(19) United States
(12) Patent Application Publication
(10) Pub. No.: US 2025/0291067 A1
(43) Pub. Date: Sep. 18, 2025

(54) Classifier for Identifying Outliers of a Position Error Distribution of Position Information and a Method for Training and Using Such a Classifier

(71) Applicant: Robert Bosch GmbH, Stuttgart (DE)

(72) Inventors: Alexander Metzger, Rottenacker (DE); Elena Sgarz, Leonberg (DE)

(21) Appl. No.: 19/078,665

(22) Filed: Mar. 13, 2025

(30) Foreign Application Priority Data
Mar. 18, 2024 (DE) 10 2024 202 510.0

(51) Int. Cl. G01S 19/40

(52) U.S. Cl. CPC G01S 19/40

(57) ABSTRACT

A classifier for identifying outliers of a position error distribution of position information is disclosed. The classifier is configured to identify position information with an increased position error as an outlier using the position information and temporally correlating boundary conditions.

This application claims priority under 35 U.S.C. § 119 to application no. DE 10 2024 202 510.0, filed on Mar. 18, 2024 in Germany, the disclosure of which is incorporated herein by reference in its entirety

The disclosure relates to a classifier for identifying outliers of a position error distribution of position information, a method for training such a classifier, a method for using such a classifier, a corresponding navigation system, and a corresponding computer program product.

### BACKGROUND

A satellite navigation device uses signals transmitted from satellites to determine a position of its receiver. Transmission errors can cause deviations in the satellite signals, whereby the position can only be determined with a position error. The position errors are not distributed normally, which can make error correction challenging.

### SUMMARY

In light of this, the approach presented here introduces a classifier for identifying outliers of a position error distribution of position information, a method for training such a classifier, a method for using such a classifier, a corresponding navigation system, and a corresponding computer program product according to the description below. Advantageous further developments and improvements of the approach presented here will emerge from the description as well.

A position error distribution of position information from locating systems does not correspond to a normal distribution. The position information has a larger proportion with a large position error than would be characteristic of a normal distribution. The position error distribution is tail-heavy or has heavy tails. Position information arranged in the tails is referred to as an outlier. In a calculation of statistical upper error limits based on a normal distribution as used to evaluate the integrity status of a locating system, either the outliers can be well covered but position information with lower position error is overestimated, or the position information with lower position error is well represented but the outliers are underrepresented.

In the approach presented herein, the position information with large position error is sorted before the remaining position information is used for navigation in the vehicle. Thus, a calculation of the error upper limit based on the normal distribution and a corresponding provision of integrity information can then be used for the position solution without position errors being over-represented or under-represented.

Sorting is carried out by a pattern recognition of reception situations in which large position errors occur more frequently. These reception situations are detected based on boundary conditions that are additionally acquired during the acquisition of the position information. The boundary conditions may be acquired and merged by various systems of the vehicle.

By the approach presented herein, both the integrity and system availability of a navigation system of a vehicle can be increased.

According to a first aspect of the disclosure, a classifier for identifying outliers of a position error distribution of position information is presented, wherein the classifier is configured to perform a pattern recognition in position information and boundary conditions correlating in time therewith, which reflect features indicative of a predictive power relative to a positioning performance, and to identify position information with an increased position error as an outlier based on results of the pattern recognition.

According to a second aspect of the disclosure, a method for training a classifier according to the first aspect is presented, wherein a plurality of untrained classifier candidates are each provided with training datasets labeled with their position error from position information and temporally correlating boundary conditions for machine learning outliers of a position error distribution of the position information, wherein each of the trained classifier candidates is provided with test datasets of position information and temporally correlating boundary conditions for recognizing outliers, wherein one of the classifier candidates is selected as the classifier if its recognition performance of outliers in the test datasets satisfies a predefined condition.

According to a third aspect of the disclosure, a method of using a classifier according to the first aspect or a classifier trained according to the second aspect is presented, wherein position information and temporally correlating boundary conditions are acquired and provided to the classifier, wherein position information identified as outliers is discarded or identified as invalid prior to use.

Ideas concerning embodiments of the present disclosure may be regarded as being based, among other things, on the thoughts and findings described below.

Position information may be a multi-dimensional coordinate value. The position information may be calculated using code and carrier phase signals from navigation satellites and/or terrestrial signal sources. The received signals have interference and/or reception of the signals may be hindered. The position information may then have a position error. The greater the signal interference, the greater the position error can be. For example, the possible position error may be depicted in a computational uncertainty of the position information.

Causes for the interference or for the impaired reception are, for example, malfunctions of the satellite and its instruments, atmospheric interference, multi-path effects, antenna effects and instrumental signal delays on the satellite and/or receiver. The malfunctions that occur are difficult to directly observe. However, the effects occurring may be depicted in boundary conditions during reception. For example, boundary conditions may be observations of satellite signal availability, its quality (e.g. carrier-to-noise ratio), or also observed signal ranges of inertial sensors of the vehicle and/or observed wheel speed ranges of wheel speed sensors of the vehicle. If causes of interference are detected during the position determination, there may be an increased probability that the resulting position information will have a large position error.

It is possible to learn which boundary conditions lead to large positional errors. Here, patterns of boundary conditions and position information where large position errors occur are learned by machine and a classifier is trained. This classifier is then used in the vehicle to recognize the learned patterns and to identify corresponding position information as outliers. A recognition performance may map how well the classifier detects the outliers.

Parameters of the selected classifier may be optimized prior to use. The parameters may be slightly changed to further improve a detection performance of the classifier.

Test datasets may be used as hidden labeled training datasets. The recognition performance may be determined using the detected outliers and the occluded labels. The test datasets and the training datasets may be acquired together and labeled and then split. In the test datasets, the label may not be legible or blocked for the classifier.

At least two classifier candidates may be trained and tested. Then, the classifier candidate with the best detection performance may be selected as the classifier. Identical training datasets and/or test datasets may be used to train the classifier candidates to obtain comparability.

Differently parameterized classifier candidates may be trained and tested. The classifier candidates may have different numbers of parameters or may have different complexity.

The boundary conditions may be estimated. The boundary conditions can be summarized from different input variables.

The method is preferably computer-implemented and can be implemented in software or hardware, for instance, or in a mixed form of software and hardware, for example in a driver assistance system.

The approach presented here also creates a navigation system, wherein the navigation system is configured to carry out, control or implement the steps of a variant of the method presented here in corresponding devices.

The navigation system can be an electrical device, i.e. a navigation device, comprising at least one computing unit for processing signals or data, at least one memory unit for storing signals or data and at least one interface and/or communication interface for reading in or outputting data embedded in a communication protocol. The computing unit can, for instance, be a signal processor, a so-called system ASIC or a microcontroller for processing sensor signals and outputting data signals as a function of the sensor signals. The memory unit can be a flash memory, an EPROM or a magnetic memory unit, for example. The interface can be configured as a sensor interface for reading in the sensor signals from a sensor and/or as an actuator interface for outputting the data signals and/or control signals to an actuator. The communication interface can be configured to read in or output the data wirelessly and/or by wire. The interfaces can also be software modules that are provided on a microcontroller alongside other software modules, for example.

A computer program product or a computer program comprising program code that can be stored on a machine-readable carrier or storage medium, such as a semiconductor memory, a hard disk memory or an optical memory, and can be used to carry out, implement and/or control the steps of the method according to one of the above-described embodiments is advantageous as well, in particular when the program product or program is executed on a computer, in a control device or an apparatus, such as a navigation system.

It should be noted that some of the possible features and advantages of the disclosure are described here with reference to different embodiments. A person skilled in the art will recognize that the features of the navigation system and the method can be suitably combined, adapted, or interchanged to arrive at further embodiments of the disclosure.

### BRIEF DESCRIPTION OF THE DRAWINGS

Embodiments of the disclosure are described in the following with reference to the accompanying drawings, wherein neither the drawings nor the description are to be construed as limiting the disclosure.

FIG. 1 shows an illustration of a classifier according to an exemplary embodiment; and

FIG. 2 shows a representation of training a classifier in accordance with an exemplary embodiment.

The figures are merely schematic and are not to scale. Identical reference numerals denote identical or functionally identical features.

### DETAILED DESCRIPTION

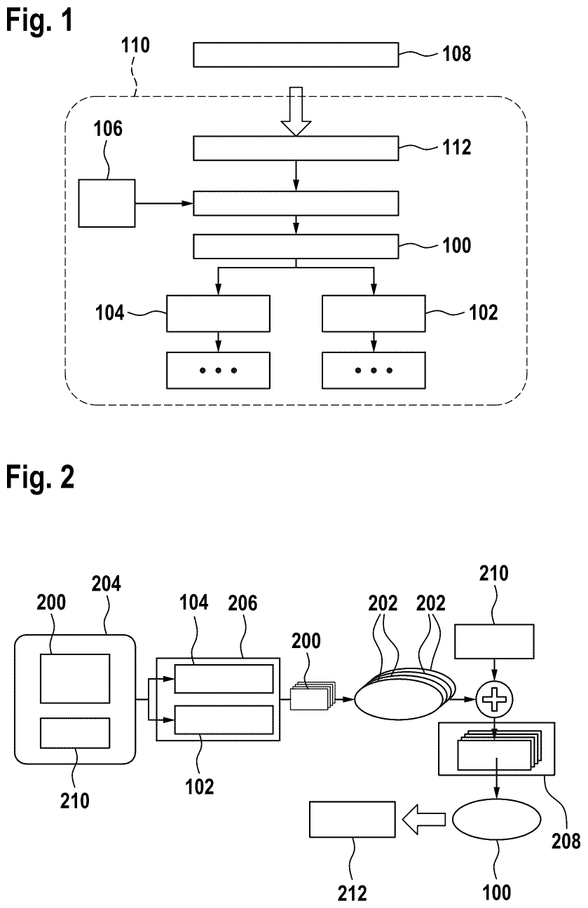

FIG. 1 shows an illustration of a classifier 100 according to an exemplary embodiment. The classifier 100 distinguishes outliers 102 and non-outliers 104 from position information 106. To this end, the classifier 100, in addition to the position information 106, uses boundary conditions 108 during an acquisition of the position information 106. For example, the boundary conditions 108 are observed, for example, by inertial sensors of a vehicle in which the classifier 100 is used, wheel speed sensors of the vehicle, and/or a satellite navigation receiver of the vehicle.

The classifier 100 is trained to recognize patterns in position information 106 of a time period and the boundary conditions acquired during the same time period 108 that indicate that the position information 106 is highly likely to have a large position error, i.e., is an outlier 102.

In an exemplary embodiment, the classifier 100 is executed on a navigation system 110 of the vehicle. In so doing, position information identified as the outliers 102 is discarded or identified as invalid prior to further use in the navigation system 110. As a result, the navigation system 110 will only navigate with position information 106 that has a low position error. The navigation can thereby achieve high accuracy and system integrity.

In an exemplary embodiment, additional boundary conditions 108 that cannot be directly measured are estimated from the raw data of the boundary conditions 108 observed on the vehicle in an estimator 112.

FIG. 2 shows a representation of training a classifier 100 in accordance with an exemplary embodiment. The classifier 100 substantially corresponds to the classifier in FIG. 1. For training, labeled training datasets 200 are passed to at least one classifier candidate 202. The training datasets 200 consist of position information and temporally correlated boundary conditions. Unlabeled training datasets 200 are read from a database 204 and labeled as outliers 102 or non-outliers 104 in an identification operation 206. The classifier candidate 202 uses machine learning to learn patterns in the position information and boundary conditions indicating that a position information is an outlier 102.

After machine learning, a recognition performance 208 of the trained classifier candidate 202 is checked using test datasets 210. The training datasets 210 also consist of position information and temporally correlated boundary conditions. The test datasets 210 are read from the same database 204 but are not labeled or occluded, such that the classifier candidate 202 cannot read information as to whether it is an outlier 102 or non-outlier 104.

If the recognition performance 208 of the classifier candidate 202 is good enough, the classifier candidate 202 is selected as the classifier 100 to be used.

In an exemplary embodiment, after training, parameters of the classifier 100 are further optimized in an optimization 212 to further improve the recognition performance 208.

In an exemplary embodiment, multiple classifier candidates 202 are trained with the same training datasets 200. The recognition performances 208 of the trained classifier candidates 202 are then compared with each other and the classifier candidate 202 having the best recognition performance 208 is selected as the classifier 100.

In an exemplary embodiment, a number of features used for pattern recognition are optimized from the training datasets 200 when training the classifier candidates 202. In so doing, the classifier candidates 202 each use different numbers of the features. When subsequently comparing the recognition performance 208, the classifier candidate 202 is then selected with the optimal number of features used, wherein the classifier candidate 202 that uses as few features as possible and as many as necessary is selected. Recognition with the minimum number of features can reduce the computing power required when using the classifier 100 in the vehicle.

Possible embodiments of the disclosure are summarized again below or presented with a slightly different choice of words.

A machine learning based monitor for recognizing outliers in the position error distribution is presented.

With the aid of the global navigation satellite system (GNSS), it is possible to spatially locate any point on earth. A GNSS satellite orbits the earth and transmits encoded signals that the GNSS receiver uses to calculate the distance between the receiver and the satellite by estimating the time difference between the reception and the transmission of the signal. The estimated distances to satellites can be converted into an estimation of the position of the receiver if enough satellites are tracked (typically more than 5). Currently, more than 130 GNSS satellites orbit the earth, meaning that at most 65 of them are usually visible on the local horizon.

With the advent of the quadruple GNSS constellation, triple frequency and external atmospheric conditions available to the Precise Point Positioning (PPP) user, and with the aid of ambiguity resolution, it is possible to achieve centimeter level accuracy with GNSS/INS based localization sensors.

Although an accuracy in the centimeter range can be achieved, there are scenarios that do not permit localization with centimeter level accuracy. This may be due to ambient conditions (poor satellite visibility) or poor signal reception (jamming/spoofing). In order to exclude as many of these epochs with decreased performance as possible, monitors have been developed in the past. These monitors typically use statistical testing or expert knowledge to recognize and exclude epochs that are likely to result in a larger positional error than the system typically provides. By rejecting these epochs, the system can deliver better positional accuracy (also expressed with the aid of performance key performance indicators (KPI)).

When collecting data with a locating system based on GNSS, the distribution of the position errors is most likely not normally distributed. A typical characteristic of error distributions is that they are “heavy tailed”, i.e. have more large errors than would be expected under the assumption of a normal distribution with the same standard deviation. Here, a monitor is presented that is capable of recognizing epochs where the errors are assumed to contribute to the “heavy tails” of the error distribution. If the majority of the large errors are eliminated by the use of such a monitor, the system may benefit in several respects. First, the higher performance requirements may be achieved if the epochs with larger errors are invalidated. In addition, the integrity of the system can be improved.

Standard protection levels (PL) are used to describe the integrity of a locating system. These are defined as the statistical error upper limit for the positioning solution. When using data-driven approaches to derive protection levels, the standard approach is to use the collected data, analyze the error distribution, and approximate the discrete error distribution by a theoretical distribution. The theoretical (parameterized) error distribution may then be used to derive exceedance values for small integrity risks.

With real data, the sample distribution cannot be approximated by a theoretical distribution without modeling errors occurring. A typical characteristic of the error distribution collected with a locating system is that it is heavily tail-heavy, i.e. has more large errors than would be expected under the assumption of a normal distribution with the same standard deviation. If an attempt is made to approximate the sample distribution by a theoretical normal distribution, the theoretical distribution can be adjusted to cover the majority of the sample data as best as possible. In this case, the core of the distribution containing the smaller errors is accurately modeled, while the tails of the theoretical distribution are smaller. The other option is to adjust the theoretical distribution not to the core behavior of the sample distribution, but to the tail behavior.

In this case, the theoretical error distribution is intended to cover all the errors of the sample and is therefore adjusted to the tails. Using the heavy tails to parameterize a theoretical normal distribution results in a significantly more conservative overall error distribution and errors in the core of the sample data are modeled for small errors. One method for deriving the error distributions from the tails is the Gaussian overbounding approach. As the derivation of an integrity-relevant feature such as the protection level (PL) cannot be based on a distribution that has its modeling errors with larger errors (in the tails), it is necessary to adjust the theoretical distribution so that it cover the tails of the sample data. The heavier the tails, the more the adjusted distribution will deviate from the core of the sample data and the larger the derived error overhang will be.

Here, a monitor is presented that is capable of recognizing epochs where the errors are assumed to contribute to the heavy tails of the error distribution (statistical outliers). If the majority of the statistical outliers are eliminated by the use of such a monitor, the system may benefit in several respects. First of all, higher performance requirements can be achieved if the epochs with larger errors are invalidated. Moreover, the integrity of a system can be improved because the theoretical distribution that is adjusted to the collected test travel data will have fewer modeling errors and will be less conservative.

There are two aspects presented. The first is in the development of monitoring within the position software (SW) that is specifically designed to recognize large errors. The definition of a large error may vary depending on when the tails of the empirical error distribution begin to deviate from the theoretical distribution. The second aspect is how the monitor is set up.

The monitors commonly used in the localization software (SW) focus on plausibility checks. For example, the estimated altitude must be less than the world's highest road (6000 m) if the test specimen is used in a car. Another test is a statistical test. The global Chisquare2 test of pseudo range residues (PRs) should be passed. This is based on the theoretical assumption that the residual deviations represent true observational uncertainty.

Further empirical values may be part of monitors based on expert judgments. Such tests could, for example, check the number of satellites for falling below a first threshold value or whether the operating time is less than a second threshold value. By combining these conditions, the system may be characterized as unreliable.

In contrast to the aforementioned tests, the monitor presented herein is derived with the aid of pattern recognition algorithms, such as decision trees, random forests, support vector machines (SVMs) and/or k-nearest neighbors (KNNs). For this purpose, a classifier is trained with the aid of marked training data. The training data is labeled using the status error. It should be ensured that the amount of training data is sufficient and covers a variety of different scenarios and conditions relevant to the use case of the navigation system. The signals on the basis of which the classifier is intended to perform its classification, the so-called input features, may be any features that have a predictive power with respect to positioning performance.

The advantage of this approach for the development of a monitor is that the only assumption is that the training data is representative of the navigation system for which the monitor is being developed (this can be checked using statistical testing, e.g. the Kolmogorov-Smirnoff test). No assumptions are required that the empirical observational errors behave as theoretical distributions (which is not the case in most real cases) or the like. In addition, the pattern recognition algorithm finds the best combination of signals according to the optimization method and cost function applied. If the classifier is provided with the same signals that are part of a monitor developed based on expert judgments, then the classifier/monitor trained with data will perform at least the same performance as the monitor based on expert judgments, mostly even better.

Such a monitor can significantly increase the overall system integrity.

The approach presented here is to monitor specifically to recognize large errors that result in strong outliers. The monitoring is carried out not on the basis of expert judgments or theoretical assumptions, but rather on the basis of pattern recognition algorithms, which are trained in a monitored manner. The recognition and rejection of large errors enables better positioning performance and system integrity.

The outlier monitor derivation approach presented herein may be broken into an offline processing part and an online processing part.

In the off-line processing part, data analysis of the acquired data is performed to determine the input characteristics for the classifier by ranking. Multiple classifiers are then trained based on the determined input features in order to determine which classifier is best for the given use case. This can be done by evaluating the key performance indicators of the training and test data. The final classifier is then selected and further optimized in terms of performance and robustness by adjusting its parameterization. The goal is to select a classifier that can be used online for online decision-making in the presence of an outlie in each epoch t.

For the online processing part, a calculation is performed at run time using the implemented classifier determined in the offline processing part. The goal is to classify whether the end position calculated at epoch t must be identified as an outlier or not based on the input feature values for epoch t.

The goal of the off-line processing part is to provide the online processing part with all the information needed. It serves to derive a classifier that, if an outlier is present, can be used for an online decision at each epoch t.

The first step is to collect enough data to perform the analysis. The amount of data is to be large enough to enable an adequate representation of the expected statistical system behavior. In addition to the amount of data, it should also be ensured that the signals within the recorded data used for the development of the classifier behave identically to the navigation system for which the monitor was developed. Tests such as Kolmogorov-Smirnoff tests to ensure the same statistical basic population may be used to check whether the data used for the offline processing part corresponds to the expected data behavior in the target vehicle. In addition, it is ensured that the data has no reference issues. Based on this data, the most relevant input signals are to be derived. Relevant signals are signals that have a high predictive power for the occurrence of an error. To determine these input feature signals, the signals may be ranked with various predictor ranking algorithms such as ANOVA tests, minimum redundancy/maximum relevance (MRMR), or correlation features. The data is then provided with the classes that the classifier is to recognize (e.g., the class labels depend on the state errors).

Once the data is identified, the dataset is broken into a training dataset and a test dataset. The training dataset is used for classifier training and the test dataset is used for validation after the classifier has been trained.

Instead of training only one classifier, multiple classifiers are now trained based on the input features from the training dataset. The classifiers may differ in their complexity, structure or parameterization. This step makes it possible to find the most suitable classifier in the design space with respect to the performance indicators relevant to the system. (Choosing the key performance indicators depends on the requirements for outlier detection, e.g., highest sensitivity, precision, or . . . )

The trained classifiers are evaluated based on both training and test data. The best classifier is then selected and further optimized by adjusting its parameterization for performance and robustness. After the final classifier has been trained and tested, the classifier is implemented/stored into the software.

With online processing, the states of the navigation filter are calculated based on the observations. The input features are selected from these states as defined in the offline part. The parameterized classifier as derived in the offline part is implemented. The value of the input characteristics for each epoch t is used to classify the epoch t as an outlier or not.

An approach to develop a monitor for a GNSS-based position sensor using pattern recognition algorithms is presented.

Each epoch can be classified into an outlier class and a non-outlier class based on input features.

The input features may be selected in an offline processing step based on predictor ranking algorithms.

The dataset used for training and testing may be identified by a predetermined threshold value.

A monitored classifier may be trained and tested based on the input features selected and the derived target identifiers.

Furthermore, an apparatus for GNSS/INS-based localization, speed and orientation determination using presented approaches is presented.

Lastly, it should be noted that terms such as “comprising”, “including”, etc. do not exclude other elements or steps and terms such as “one” or “a” do not exclude a plurality. Reference numerals in the claims should not be construed as limitations.

What is claimed is:

1. A classifier for identifying outliers of a position error distribution of position information, wherein the classifier is configured to:
perform a pattern recognition in position information and temporally correlate boundary conditions reflecting features indicative of a predictive power relative to a positioning performance, and
identify position information with an increased position error as an outlier based on results of the pattern recognition.

2. A method for training the classifier according to claim 1, comprising:
providing each of a plurality of untrained classifier candidates with training datasets labeled with their position error from position information and temporally correlating boundary conditions for machine learning outliers of a position error distribution of the position information;
providing each of the trained classifier candidates with test datasets of position information and temporally correlating boundary conditions for recognizing outliers; and
selecting one of the classifier candidates as the classifier if its recognition performance of outliers in the test datasets satisfies a predefined condition.

3. The method according to claim 2, further comprising optimizing parameters of the selected classifier prior to use.

4. The method according to claim 2, further comprising:
using occluded labeled training datasets as the test datasets; and
using the detected outliers and the occluded labels to determine the recognition performance.

5. The method according to claim 2, further comprising:
training and testing at least two classifier candidates; and
selecting the classifier candidate having the best recognition performance as the classifier.

6. The method according to claim 2, further comprising training and testing differently parameterized classifier candidates.

7. A method for using the classifier according to claim 1, comprising:
acquiring and providing to the classifier position information and temporally correlated boundary conditions; and
discarding prior to use position information identified as an outlier.

8. The method according to claim 7, further comprising estimating boundary conditions.

9. A navigation system, wherein the navigation system is configured to execute, implement and/or control the method according to claim 7.

10. A computer program product which is configured to direct a processor to execute, implement and/or control the method according to claim 2 when said computer program product is executed.

11. A machine-readable storage medium on which the computer program product according to claim 10 is stored.

12. A method for using a classifier trained using the method according to claim 2, comprising:
acquiring and providing to the classifier position information and temporally correlated boundary conditions; and
discarding prior to use position information identified as an outlier.

13. A navigation system, wherein the navigation system is configured to execute, implement and/or control the method according to claim 12.
